(19) United States
(12) Patent Application Publication
(10) Pub. No.: US 2022/0325200 A1
(43) Pub. Date: Oct. 13, 2022

(54) SOLID SURFACTANT COMPOSITIONS

(71) Applicant: BASF SE, Ludwigshafen am Rhein (DE)

(72) Inventors: Dominik LANZINGER, Ludwigshafen (DE); Juergen TROPSCH, Ludwigshafen (DE); Yannick FUCHS, Shanghai (CN)

(21) Appl. No.: 17/639,997

(22) PCT Filed: Sep. 7, 2020
(86) PCT No.: PCT/EP2020/074793

§ 371 Date: Mar. 3, 2022

Related U.S. Application Data
(60) Provisional application No. 62/896,625, filed on Sep. 6, 2019.

(51) Int. Cl. C11D 1/722; C11D 3/37

(52) U.S. Cl. CPC C11D 1/722; C11D 3/3784

(57) ABSTRACT

Disclosed herein is a solid surfactant composition including at least one polymer P1) that includes polymerized units of at least one monomer A), selected from the group consisting of α, β-ethylenically unsaturated carboxylic acids, salts of α,β-ethylenically un-saturated carboxylic acids, α, β-ethylenically unsaturated carboxylic acid anhydrides and mixtures thereof, and at least one nonionic surfactant of the general formula (I), characterized in that the solid surfactant composition has a glass transition temperature (Tg) of at least 50° C., determined by differential scanning calorimetry according to DIN EN ISO 11357-2, at a heating rate of 20 K/min. Additionally disclosed herein is a method of using the solid surfactant composition in a cleaning formulation.

### FIELD OF THE INVENTION

The present invention relates to a solid surfactant composition comprising at least one polymer P1) that comprises polymerized units of at least one monomer A) selected from the group consisting of α,β-ethylenically unsaturated carboxylic acids, salts of α,β-ethylenically unsaturated carboxylic acids, α,β-ethylenically unsaturated carboxylic acid anhydrides, mixtures thereof; and at least one nonionic surfactant of the general formula (I), characterized in that the solid surfactant composition has a glass transition temperature (T_{g}) of at least 50° C., determined by differential scanning calorimetry according to DIN EN ISO 11357-2, at a heating rate of 20 K/min. The present invention further relates to the use of the solid surfactant composition in a cleaning formulation.

### BACKGROUND OF THE INVENTION

Cleaning compositions usually comprise a mixture of different surfactants, a proportion of nonionic surfactants generally being present in such a surfactant mixture. Such nonionic surfactants are mostly in the form of liquids of varying viscosity. However, for certain surfactant applications, nonionic surfactant in solid form are desired.

There have been attempts made in the prior art to prepare nonionic surfactant compositions which are non-sticky by dusting them with inorganic salts to obtain powdered granulates. However, a problem associated with these processes that the abrasion resistance of such powdered granulates leaves little to be desired, as a result of which an undesired fine dust often forms subsequent to storage and transportation of such surfactant compositions. Alternatively, it has also been possible to apply nonionic surfactants to a laundry detergent powder by other methods customarily used for applying liquid compounds to solids, for example by nozzle introduction in a moving bed. However, this procedure is disadvantageous for various reasons, one of the reasons being that there is no homogeneous distribution of surfactant, but coating of the surfactant and only low surfactant content can be obtained.

US 2002/0198133 A1 discloses a nonionic surfactant mixture in solid form, characterized in that it has a core and a shell, where the core comprises at least one nonionic surfactant and the shell comprises, as coating substance, at least one anionic surfactant or at least one nonionic surfactant which is not present in the core or at least one zwitterionic surfactant or a mixture of two or more of said surfactants.

U.S. Pat. No. 3,915,878 A describes a method for converting liquid nonionic surfactants to a dry free flowing form by mixing them with micro-sized silica particles chosen from the group consisting of silica gels, silica aerogels, precipitated silicas and pyrogenic silicas. The micro-sized silica particles do not have any functional contribution to the cleaning composition.

Due to the ever-increasing demand for higher performance of the cleaning compositions, it is desirable to provide nonionic surfactants in solid, non-sticky form with a high surfactant content such that they allow high dosing efficiency at low costs and can be incorporated in a wide variety of solid cleaning compositions.

Accordingly, it is an object of the presently claimed invention to provide nonionic surfactants in solid, non-sticky form with a high loading of nonionic surfactant for an easy incorporation in solid cleaning compositions.

### SUMMARY OF THE INVENTION

Surprisingly, it was found that by adding certain carboxyl group containing polymers to nonionic surfactants, solid nonionic surfactants are obtained. The incorporation of the carboxyl group containing polymers also contributes to the functional performance of the compositions in cleaning applications. The solid nonionic surfactant composition that is obtained according to the presently claimed invention is non-sticky at 23° C. and has a high loading of the nonionic surfactant.

Thus, in one aspect, the presently claimed invention is directed to a solid surfactant composition comprising
(i) at least one polymer P1) that comprises polymerized units of at least one monomer A), selected from the group consisting of α, β-ethylenically unsaturated carboxylic acids, salt of α, β-ethylenically unsaturated carboxylic acids, α, β-ethylenically unsaturated carboxylic acid anhydrides, mixtures thereof, and
(ii) at least one nonionic surfactant of the general formula (I),

R₁-(A)ₓ-(B)_{y1}-(A)_{z}-(B)_{y2}—R₂ (I),
wherein
R₁ and R₂ independently denote H or linear or branched, substituted or unsubstituted C₁-C₂₂ alkyl,
A denotes CH₂—CH₂—O,
B denotes CH₂—CHR₃—O, wherein R₃ denotes H or linear or branched, unsubstituted C₁-C₁₀ alkyl,
X is an integer in the range from 0 to 35,
y₁ is an integer in the range from 0 to 60,
y₂ is an integer in the range from 0 to 35, and
z is an integer in the range from 0 to 35,
   wherein the sum of x+y₁+z+y₂ is at least 1,
   characterized in that the solid surfactant composition has a glass transition temperature (T_{g}) of at least 50° C., determined by differential scanning calorimetry according to DIN EN ISO 11357-2, at a heating rate of 20 K/min.

In another aspect, the presently claimed invention is directed to the use of the solid surfactant composition, as described above and below, in a cleaning formulation.

### DETAILED DESCRIPTION OF THE INVENTION

Before the present compositions and formulations of the invention are described, it is to be understood that this invention is not limited to particular compositions and formulations described, since such compositions and formulation may, of course, vary. It is also to be understood that the terminology used herein is not intended to be limiting, since the scope of the present invention will be limited only by the appended claims.

If hereinafter a group is defined to comprise at least a certain number of embodiments, this is meant to also encompass a group which preferably consists of these embodiments only. Furthermore, the terms “first”, “second”, “third” or “(a)”, “(b)”, “(c)”, “(d)” etc. and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein. In case the terms “first”, “second”, “third” or “(A)”, “(B)” and “(C)” or “(a)”, “(b)”, “(c)”, “(d)”, “i”, “ii” etc. relate to steps of a method or use or assay there is no time or time interval coherence between the steps, that is, the steps may be carried out simultaneously or there may be time intervals of seconds, minutes, hours, days, weeks, months or even years between such steps, unless otherwise indicated in the application as set forth herein above or below.

In the following passages, different aspects of the invention are defined in more detail. Each aspect so defined may be combined with any other aspect or aspects unless clearly indicated to the contrary. In particular, any feature indicated as being preferred or advantageous may be combined with any other feature or features indicated as being preferred or advantageous.

Reference throughout this specification to ‘one embodiment’ or ‘an embodiment’ means that a particular feature, structure or characteristic described in connection with the embodiment is included in at least one embodiment of the presently claimed invention. Thus, appearances of the phrases ‘in one embodiment’ or ‘in an embodiment’ in various places throughout this specification are not necessarily all referring to the same embodiment but may refer to the same embodiment. Further, as used in the following, the terms “preferably”, “more preferably”, “even more preferably”, “most preferably” and “in particular” or similar terms are used in conjunction with optional features, without restricting alternative possibilities. Thus, features introduced by these terms are optional features and are not intended to restrict the scope of the claims in any way.

Furthermore, the particular features, structures or characteristics may be combined in any suitable manner, as would be apparent to a person skilled in the art from this disclosure, in one or more embodiments. Furthermore, while some embodiments described herein include some, but not other features included in other embodiments, combinations of features of different embodiments are meant to be within the scope of the presently claimed invention, and form different embodiments, as would be understood by those in the art. For example, in the appended claims, any of the claimed embodiments can be used in any combination.

Further, it shall be noted that the terms “at least one”, “one or more” or similar expressions indicating that a feature or element may be present once or more than once typically will be used only once when introducing the respective feature or element. In the following, in most cases, when referring to the respective feature or element, the expressions “at least one” or “one or more” will not be repeated, non-withstanding the fact that the respective feature or element may be present once or more than once.

Furthermore, the ranges defined throughout the specification include the end values as well i.e. a range of 1 to 10 implies that both 1 and 10 are included in the range. For the avoidance of doubt, the applicant shall be entitled to any equivalents according to the applicable law.

Certain terms are first defined so that this disclosure can be more readily understood. Unless defined otherwise, all technical and scientific terms used herein have the same meaning as commonly understood by one of ordinary skill in the art to which embodiments of the invention pertain.

In an aspect, the presently claimed invention is directed to a solid surfactant composition comprising
(i) at least one polymer P1) that comprises polymerized units of at least one monomer A), selected from the group consisting of α, β-ethylenically unsaturated carboxylic acids, salt of α, β-ethylenically unsaturated carboxylic acids, α, β-ethylenically unsaturated carboxylic acid anhydrides, mixtures thereof, and
(ii) at least one nonionic surfactant of the general formula (I),

R₁-(A)ₓ-(B)_{y1}-(A)_{z}-(B)_{y2}—R₂ (I),
wherein
R₁ and R₂ independently denote H or linear or branched, substituted or unsubstituted C₁-C₂₂ alkyl,
A denotes CH₂—CH₂—O,
B denotes CH₂—CHR₃—O, wherein R₃ denotes H or linear or branched, unsubstituted C₁-C₁₀ alkyl,
x is an integer in the range from 0 to 35,
y₁ is an integer in the range from 0 to 60,
y₂ is an integer in the range from 0 to 35, and
z is an integer in the range from 0 to 35,
   wherein the sum of x+y₁+z+y₂ is at least 1,
   characterized in that the solid surfactant composition has a glass transition temperature (T_{g}) of at least 50° C., determined by differential scanning calorimetry according to DIN EN ISO 11357-2, at a heating rate of 20 K/min.

The term ‘solid’ herein refers to the physical state of the composition in a solid form under the standard conditions (23° C., 1 bar).

The glass transition temperatures (T_{g}) described in the context of the presently claimed invention is determined by means of differential scanning calorimetry (DSC). The DSC analysis on one and the same sample is appropriately repeated once or twice, in order to ensure a defined thermal history of the respective surfactant-polymer compositions. The heating and cooling rates are 20 K/min.

Polymer P1)

The at least one polymer P1) comprises polymerized units of at least one monomer A), selected from the group consisting of α, β-ethylenically unsaturated carboxylic acids, salt of α, β-ethylenically unsaturated carboxylic acids, α, β-ethylenically unsaturated carboxylic acid anhydrides and mixtures thereof.

As used herein, the term “polymer” generally denotes a molecule having monomer units between five and a hundred. It includes, but is not limited to, homopolymers, copolymers, such as for example, block, graft, random and alternating co-polymers. Furthermore, unless otherwise specifically limited, the term “polymer” shall include all possible isomeric configurations of the monomers, including, but are not limited to isotactic, syndiotactic and random symmetries configurations, and combinations thereof. Furthermore, unless otherwise specifically limited, the term “polymer” shall include all possible geometrical configurations of the molecule.

The α,β-ethylenically unsaturated carboxylic acids are preferably selected from acrylic acid, methacrylic acid, ethacrylic acid, maleic acid, fumaric acid, itaconic acid, α-chloroacrylic acid, crotonic acid, citraconic acid, mesaconic acid, glutaconic acid and aconitic acid. Suitable salts of the aforementioned acids are, in particular, the sodium, potassium, ammonium and sodium phosphonate salts.

Preferably, the α,β-ethylenically unsaturated carboxylic acids are used for the polymerization in non-neutralized form. If the α,β-ethylenically unsaturated carboxylic acids are used for the polymerization in partially neutralized form, then the acid groups are neutralized, preferably to at most 50 mol %, particularly preferably to at most 30 mol %.

Preferred α, β-ethylenically unsaturated carboxylic acid anhydrides are selected from the group consisting of acrylic anhydride, methacrylic anhydride, maleic anhydride, itaconic anhydride, citraconic anhydride and 2,3-dimethylmaleic anhydride.

In a more preferred embodiment, the monomer A) is selected from the group consisting of α, β-ethylenically unsaturated carboxylic acids, salts of α, β-ethylenically unsaturated carboxylic acids and mixtures thereof.

In a more preferred embodiment, the at least one monomer A) is selected from the group consisting of acrylic acid, methacrylic acid, maleic acid, fumaric acid, itaconic acid, ethacrylic acid, α-chloroacrylic acid, crotonic acid, citraconic acid, mesaconic acid, glutaconic acid, aconitic acid, maleic anhydride, itaconic anhydride and salts thereof.

Most preferably, the monomer A) is selected from the group consisting of acrylic acid, methacrylic acid, maleic acid, fumaric acid, itaconic acid, salts of the aforementioned carboxylic acids and mixtures thereof.

The at least one polymer P1) may optionally comprise polymerized units of at least one monomer B) which is selected from the group consisting of unsaturated phosphonic acids, salts of unsaturated phosphonic acids, sodium phosphinate and mixtures thereof.

In an embodiment, the at least one monomer B) is selected from the group consisting of vinyl phosphonic acid, allyl phosphonic acid, sodium phosphinate, salts and mixtures thereof.

In a preferred embodiment, the at least one monomer B) is sodium phosphinate.

In an embodiment, the at least one polymer P1) is obtained by free-radical polymerization of at least one monomer A).

In another embodiment, the at least one polymer P1) is obtained by free-radical polymerization of at least one monomer B).

In a preferred embodiment, the at least one polymer P1) is obtained by free-radical polymerization of at least one monomer A), at least one monomer B) and mixtures thereof.

In an embodiment, the at least one polymer P1) is a homopolymer or a copolymer of at least one monomer A), at least one monomer B) and mixtures thereof.

In a preferred embodiment, the at least one polymer P1) is a homopolymer or a copolymer of acrylic acid, methacrylic acid, salts of acrylic acid, salts of methacrylic acid and sodium phosphinate.

In a more preferred embodiment, the at least one polymer P1) is a homopolymer of acrylic acid. In a more preferred embodiment, the at least one polymer P1) is represented by the general formula (II)

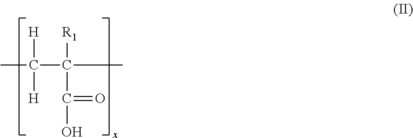

wherein
R₁ is selected from H and methyl; and
x is an integer in the range of 10 to 100.

In a most preferred embodiment of the at least one polymer P1) of general formula (II), R₁ is H and x is an integer in the range of 20 to 70.

In another preferred embodiment, the at least one polymer P1) is a copolymer of acrylic acid and sodium phosphinate. In a more preferred embodiment, the at least one polymer P1) is represented by general formula (III).

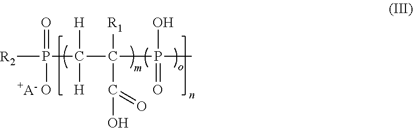

wherein
R₁ is selected from H and methyl,
R₂ is selected from H and —(—CH₂—CR₁COOH—)ₘ—
A is selected from H, sodium and potassium,
m is an integer in the range of 5 to 60; and
n is an integer in the range of 1 to 60
o is 0 or 1.

Some of the terminal groups of the at least one polymer P1) of general formula (III) may be carboxylate, but most are preferably phosphonate as represented in structure (III). The at least one polymer P1) of the general formula (III) can be prepared by the reaction of acrylic acid and sodium hypophosphite in the presence of a free radical initiator. For example, low molecular weight polyphosphinoacrylic acid may be prepared by a slow addition of acrylic acid to an aqueous solution of sodium hypophosphite containing a catalytic amount of potassium persulfate at 90° C. to 95° C. under nitrogen atmosphere.

In a preferred embodiment, the at least one polymer P1) of the general formula (III) has a weight average molecular weight in the range of 300 to 8000 g/mol, more preferably in the range of 500 to 7000 g/mol, still more preferably in the range of 1000 to 6000 g/mol and most preferably in the range of 1500 to 5000 g/mol. The reaction products prepared at 40 percent solids are clear to slightly hazy aqueous solutions with a pH of 2.5 to 3.0. By varying the concentration of sodium hypophosphite and rate of acrylic acid addition, products having weight average molecular weights from 1500 to 5000 are readily obtained.

In another preferred embodiment, the at least one polymer P1) is a polymeric complex comprising a copolymer of acrylic acid and sodium phosphinate salt. In a more preferred embodiment, the at least one polymer P1) is represented by general formula (IV)

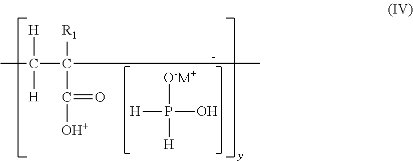

wherein
R₁ is selected from H and methyl,
y is an integer in the range of 5 to 60, and
M is selected from sodium, potassium, ammonium and amino.

In a preferred embodiment of the at least one polymer of general formula (IV), R₁ is H and M is sodium. A particularly preferred polymeric complex of this type is 2-propenoic acid, complexed with sodium phosphinate.

In a more preferred embodiment, the at least one polymer P1) is selected from the group consisting of homopolymer of acrylic acid and copolymers of acrylic acid and sodium phosphinate. In a more preferred embodiment, the at least one polymer P1) is represented by general formula (II), (III), (IV) and mixtures thereof.

Number-average molecular weight (Mₙ), weight-average molecular weight (M_{w}) and polydispersity of the polymer P1) are determined by gel permeation chromatography (GPC): Eluent 0.01 mol/l phosphate buffer, column set of 2 separating columns of column length 30 cm each, column temperature 35° C., pH=7.4, +0.01 M NaN₃ in deionized water. For calibration, polyacrylic acid (neutralized) standard is used. Flow rate is 0.8 mL/min, concentration 2 mg/mL, injection 100 μL. Detector: RID (Refractive Index Detector) Agilent 1200”.

In an embodiment, the at least one polymer P1) has a number-average molecular weight (Mₙ) in the range of 1,000 to 30,000 g/mol as determined by gel permeation chromatography.

In a more preferred embodiment, the at least one polymer P1) has a number-average molecular weight (Mₙ) in the range of 1,000 to 25,000 g/mol as determined by gel permeation chromatography.

In a most preferred embodiment, the at least one polymer P1) has a number-average molecular weight (Mₙ) in the range of 1,000 to 20,000 g/mol as determined by gel permeation chromatography.

In an embodiment, the at least one polymer P1) has a weight average molecular weight (M_{w}) in the range of 1,000 to 40,000 g/mol as determined by gel permeation chromatography.

In a more preferred embodiment, the at least one polymer P1) has a weight average molecular weight (M_{w}) in the range of 1,000 to 35,000 g/mol as determined by gel permeation chromatography.

In a most preferred embodiment, the at least one polymer P1) has a weight average molecular weight (M_{w}) in the range of 1,000 to 30,000 g/mol as determined by gel permeation chromatography.

Polydispersity refers to M_{w}/Mₙ, or ratio of weight average molecular weight to number average molecular weight. In a preferred embodiment, the polymer P1) has a polydispersity in the range of 1.2 to 3.0, more preferably in the range of 1.3 to 2.8 and most preferably in the range of 1.3 to 2.5, as determined by gel permeation chromatography.

In an embodiment, the pH of 10% aqueous solution of the at least one polymer P1) is in the range of 2 to 4. The pH is measured with a glass electrode and a pH meter.

In a preferred embodiment, the at least one polymer P1) is present in an amount in the range of 20% to 80% by weight, more preferably in the range of 22% to 78% by weight, and most preferably in the range of 23% to 76% by weight, in each case based on the total weight of the solid surfactant composition.

Surfactant

The at least one nonionic surfactant of the presently claimed invention is the compound of the general formula (I),

R₁-(A)ₓ-(B)_{y1}-(A)_{z}-(B)_{y2}—R₂ (I),

wherein
R₁ and R₂ independently denote H or linear or branched, substituted or unsubstituted C₁-C₂₂ alkyl,
A denotes CH₂—CH₂—O,
B CH₂—CHR₃—O, wherein R₃ denotes H or linear or branched, unsubstituted C₁-C₁₀ alkyl,
x is an integer in the range from 0 to 35,
y₁ is an integer in the range from 0 to 60,
y₂ is an integer in the range from 0 to 35,
z is an integer in the range from 0 to 35, and
wherein the sum of x+y₁+z+y₂ is at least 1.

Preferably the sum of x+y₁+z+y₂ is in the range of 1 to 100, more preferably the sum of x+y₁+z+y₂ is in the range of 1 to 75 even more preferably the sum of x+y₁+z+y₂ is in the range of 2 to 75 and most preferably the sum of x+y₁+z+y₂ is in the range of 2 to 70.

Within the context of the present invention, the term “alkyl”, as used herein, refers to acyclic saturated aliphatic residues, including linear or branched alkyl residues. Furthermore, the alkyl residue is preferably unsubstituted and includes as in the case of C₁-C₂₂ alkyl 1 to 22 carbon atoms.

As used herein, “branched” denotes a chain of atoms with one or more side chains attached to it. Branching occurs by the replacement of a substituent, e.g., a hydrogen atom, with a covalently bonded aliphatic moiety.

Representative examples of linear and branched, unsubstituted C₁-C₂₂ alkyl include, but are not limited to methyl, ethyl, n-propyl, n-butyl, n-pentyl, n-hexyl, n-heptyl, n-octyl, n-nonyl, n-decyl, n-undecyl, n-dodecyl, n-tridecyl, n-tetradecyl, n-pentadecyl, n-hexadecyl, n-heptadecyl, n-octadecyl, n-nonadecyl, n-eicosyl, n-heneicosyl, n-docosyl, isopropyl, isobutyl, isopentyl, isohexyl, isoheptyl, isooctyl, isononyl, isodecyl, isoundecyl, isododecyl, isotridecyl, isotetradecyl, isopentadecyl, isohexadecyl, isoheptadecyl, isooctadecyl, isononadecyl, isoeicosyl, isoheneicosyl, isodocosyl, 2-propyl heptyl, 2-ethyl hexyl and t-butyl.

The preferred embodiments A to E of the at least one nonionic surfactant of general formula (I) according to the presently claimed invention are summarized in Table-1 below: 0

| Compound of | | | | | |
|---|---|---|---|---|---|
| general formula | | | | | |
| (1) | A | B | c | D | E |
| R₁ | Linear or branched, un- | H | Linear or branched, | Linear or branched, | H |
| | substituted C₁—C₂₂ alkyl | | unsubstituted C₁—C₂₂ | unsubstituted C₁—C₂₂ | |
| | | | alkyl | alkyl | |
| R₂ | H | H | H or linear or | C₁—C₂₂ alkyl | H |
| | | | branched, unsubstituted | | |
| | | | C₁—C₁₀ alkyl | | |
| R₃ | H or linear or branched, | Linear or | H or linear or | H or linear or | H or linear or |
| | unsubstituted C₁—C₁₀ | branched, | branched, | branched, | branched, |
| | alkyl | unsubstituted | unsubstituted | unsubstituted | unsubstituted |
| | | C₁—C₁₀ alkyl | C₁—C₁₀ alkyl | C₁—C₁₀ alkyl | C₁—C₁₀ alkyl |
| x | 0 to 30 | 1 to 25 | 1 to 25 | 1 to 25 | 0 |
| y₁ | 0 to 30 | 5 to 60 | 0 to 30 | 1 to 30 | 1 to 30 |
| y₂ | 0 to 30 | 0 | 0 | 0 | 1 to 30 |
| Z | 0 to 30 | 1 to 25 | 0 | 0 to 20 | 1 to 20 |
| x + y₁ + z + y₂ | 1 to 70 | 1 to 100 | 1 to 55 | 1 to 75 | 1 to 80 |

The more preferred embodiments F to J of the at least one nonionic surfactant of general formula (I) according to the presently claimed invention are summarized in the Table-2 below:

| Compound of | | | | | |
|---|---|---|---|---|---|
| general formula | | | | | |
| (1) | F | G | H | I | J |
| R₁ | Linear or branched, un- | H | Linear or branched, | Linear or branched, | H |
| | substituted C₄—C₂₂ alkyl | | unsubstituted C₁—C₂₂ | unsubstituted C₁—C₂₂ | |
| | | | alkyl | alkyl | |
| R₂ | H | H | H or linear or | C₁—C₂₂ alkyl | H |
| | | | branched, unsubstituted | | |
| | | | C₁—C₅ alkyl | | |
| R₃ | Linear or branched, un- | Linear or branched, | H or linear or | Linear or branched, | methyl |
| | substituted C₁—C₁₀ alkyl | unsubstituted C₁—C₅ | branched, unsubstituted | unsubstituted C₁—C₁₀ | |
| | | alkyl | C₁—C₅ alkyl | alkyl | |
| x | 0 to 25 | 1 to 20 | 1 to 25 | 1 to 20 | 0 |
| y₁ | 1 to 25 | 5 to 60 | 0 to 20 | 1 to 25 | 5 to 30 |
| y₂ | 0 to 25 | 0 | 0 | 0 | 5 to 30 |
| Z | 0 to 25 | 1 to 15 | 0 | 0 to 15 | 3 to 20 |
| x + y₁ + z + y₂ | 1 to 60 | 1 to 70 | 1 to 30 | 1 to 70 | 1 to 75 |

The most preferred embodiments K to 0 of the at least one nonionic surfactant of general formula (I) according to the presently claimed invention are summarized in the Table-3 below:

| Compound of | | | | | |
|---|---|---|---|---|---|
| general formula (1) | K | L | M | N | O |
| R₁ | Linear or | H | Linear or branched, | Linear or branched, | H |
| | branched, un- | | unsubstituted C₁—C₂₂ alkyl | unsubstituted C₁—C₂₂ alkyl | |
| | substituted | | | | |
| | C₈—C₂₀ alkyl | | | | |
| R₂ | H | H | H or linear, unsubstituted | C₁—C₂₂ alkyl | H |
| | | | C₁—C₄ alkyl | | |
| R₃ | Linear or | methyl | H or methyl | Linear or branched, | methyl |
| | branched, un- | | | unsubstituted C₁—C₁₀ alkyl | |
| | substituted C₁ | | | | |
| | to C₅ alkyl | | | | |
| x | 0 to 20 | 1 to 15 | 1 to 20 | 1 to 15 | 0 |
| y₁ | 1 to 20 | 5 to 55 | 0 to 15 | 1 to 20 | 10 to 30 |
| y₂ | 0 to 20 | 0 | 0 | 0 | 10 to 30 |
| Z | 0 to 20 | 1 to 10 | 0 | 0 to 10 | 3 to 18 |
| x + y₁ + z + y₂ | 1 to 50 | 1 to 60 | 1 to 20 | 1 to 65 | 1 to 70 |

The at least one nonionic surfactant of general formula (I) according to embodiments A, F and K can be prepared by alkoxylation of fatty alcohol R₁—OH. When the fatty alcohol R₁—OH is derived from a natural source, it is common to have mixtures, e.g. of C₁₀ and C₁₆ alcohols, C₁₆ and C₁₈ alcohols or C₁₂ and C₁₄ alcohols. Fatty alcohol R₁—OH can also be synthesized (for example by oxo process) from olefin mixtures and in this case, it is common to have mixtures e.g. of C₁₃ and C₁₅ alcohols.

The at least one nonionic surfactant of general formula (I) according to embodiments B, G and L are the block copolymers of propylene oxide and ethylene oxide wherein the copolymers include first and second blocks of repeating ethylene oxide (EO) units and a block of repeating propylene oxide (PO) unit interposed between first and second block of repeating ethylene units represented by formula (V),

HO—(CH₂CH₂O)ₓ(CH(CH₃)CH₂O)_{y1}(CH₂CH₂O)_{z}—H; (V)

In a preferred embodiment, the at least one nonionic surfactant of general formula (I) according to embodiments B, G and L have a ratio of ethylene oxide (EO) units to propylene oxide (PO) units of from 1:10 to 10:1 and an average molecular weight from 500 to 10,000 g/mol.

The at least one nonionic surfactant of general formula (I) according to embodiments C, H and M are the block copolymers of ethylene oxide and higher alkylene oxide functionalized/capped with fatty alcohols. Preferred higher alkylene oxides are propylene oxide, butylene oxide and pentylene oxide. The preferred ratio of ethylene oxide to the higher alkylene oxide units is 1:2 to 5:2.

The at least one nonionic surfactant of general formula (I) according to embodiments E, J and O are the block copolymers of propylene oxide and ethylene oxide wherein the copolymers include first and second blocks of repeating propylene oxide (PO) units and a block of repeating ethylene oxide (EO) unit interposed between first and second block of repeating propylene units as represented by formula (VI),

HO—(CH(CH₃)CH₂O)_{y1}—(CH₂CH₂O)_{z}—(CH(CH₃)CH₂O)_{y2}—H. (VI)

In a preferred embodiment, the at least one nonionic surfactant of general formula (I) according to embodiments E, J and O have a ratio of ethylene oxide (EO) units to propylene oxide (P0) units of from 1:10 to 10:1 and an average molecular weight from 500 to 10,000 g/mol.

Suitable nonionic surfactant of the general formula (I) are as listed in Table-4.

TABLE 4

| | | | | | | | | HLB |
|---|---|---|---|---|---|---|---|---|
| | R₁ | x | y₁ | z | y₂ | R₂ | R₃ | value |
| Surfactant 1 | C₁₀ | 0 | 3 | 15 | 18 | H | methyl | 6.40 |
| | branched, | | | | | | | |
| | unsubstituted | | | | | | | |
| Surfactant 2 | C₁₃-C₁₅, | 9.8 | 2.1 | 0 | 0 | H | ethyl | 10.5 |
| | linear & | | | | | | | |
| | branched, | | | | | | | |
| | unsubstituted | | | | | | | |
| Surfactant 3 | C₁₃-C₁₅, | 6.1 | 1.9 | 0 | 0 | H | ethyl | 8.90 |
| | linear & | | | | | | | |
| | branched, | | | | | | | |
| | unsubstituted | | | | | | | |
| Surfactant 4 | C₁₃-C₁₅ | 4.8 | 2 | 0 | 0 | H | ethyl | 7.7 |
| | branched, | | | | | | | |
| | unsubstituted | | | | | | | |
| Surfactant 5 | C₁₂-C₁₅, | 0 | 5 | 2.5 | 0 | H | methyl | 3.4 |
| | linear & | | | | | | | |
| | branched, | | | | | | | |
| | unsubstituted | | | | | | | |
| Surfactant 6 | C₁₂-C₁₅, | 3.5 | 5.5 | 0 | 0 | H | methyl | 4.80 |
| | linear & | | | | | | | |
| | branched, | | | | | | | |
| | unsubstituted | | | | | | | |
| Surfactant 7 | C₁₀ | 5.4 | 4.7 | 0.5 | 0 | H | methyl | 7.60 |
| | branched, | | | | | | | |
| | unsubstituted | | | | | | | |
| Surfactant 8 | C₁₆-C₁₈, | 3.9 | 14 | 0 | 0 | H | methyl | 2.80 |
| | linear & | | | | | | | |
| | branched, | | | | | | | |
| | unsubstituted | | | | | | | |
| Surfactant 9 | C₁₂-C₁₄, | 3 | 6 | 0 | 0 | H | methyl | 3.90 |
| | linear & | | | | | | | |
| | branched, | | | | | | | |
| | unsubstituted | | | | | | | |
| Surfactant 10 | C₁₂-C₁₈, | 10 | 0 | 0 | 0 | butyl | H | 12.70 |
| | linear and | | | | | | | |
| | branched, | | | | | | | |
| | unsubstituted | | | | | | | |
| Surfactant 11 | H | 1 | 16 | 1 | 0 | H | methyl | 2.00 |
| Surfactant 12 | H | 2 | 30 | 2 | 0 | H | methyl | 2.00 |
| Surfactant 13 | H | 3 | 41 | 3 | 0 | H | methyl | 2.00 |
| Surfactant 14 | H | 3 | 47 | 3 | 0 | H | methyl | 2.00 |
| Surfactant 15 | H | 0 | 20-25 | 5-15 | 20-25 | H | methyl | 4.00 |
| Surfactant 16 | C₁₃ | 2 | 0 | 0 | 0 | H | — | 6.1 |
| | branched, | | | | | | | |
| | unsubstituted | | | | | | | |

In an embodiment, the at least one nonionic surfactant of the general formula (I) has a hydrophilic-lipophilic balance (HLB) value in the range of 2 to 17.

In a preferred embodiment, the at least one nonionic surfactant of the general formula (I) has an HLB value in the range of 2 to 11 when R₂ is H.

In another preferred embodiment, the at least one nonionic surfactant of the general formula (I) has an HLB value in the range of 2 to 17 when R₂ is linear or branched, substituted or unsubstituted C₁-C₂₂ alkyl.

The HLB value represents the hydrophilic-lipophilic balance of the molecule. The lower the HLB value the more hydrophobic the material is, and vice versa. The HLB values can be calculated according to the method given in Griffin, J. Soc. Cosmetic Chemists, 5 (1954) 249-256.

Griffith's method for nonionic surfactants as described in 1954 is as follows:

HLB=20×Mₕ/M

where
Mₕ is the molecular mass of the hydrophilic portion of the molecule; and
M is the molecular mass of the whole molecule. Only the EO part in the surfactants is regarded as hydrophilic, all other parts contribute only to the whole molecule.

In a preferred embodiment, the at least one nonionic surfactant is present in an amount in the range of 20% to 80% by weight, more preferably in the range of 22% to 78% by weight, and most preferably in the range of 23% to 76% by weight, in each case based on the total weight of the solid surfactant composition.

### Process

The solid surfactant composition can be prepared by the following process steps:
i. adding the at least one non-ionic surfactant and the polymer P1) into a mixer;
ii. tempering the mixture of step i) to 60° C.;
iii. mixing the mixture of step ii) at 2500 to 3000 rpm for a time in the range of 1 to 5 minutes; and
iv. freeze drying the content of the resulting mixture of step iii).

The glass transition temperature (T_{g}) of the solid surfactant composition is determined by differential scanning calorimetry according to DIN EN ISO 11357-2. The following temperature profile was applied, and the measurement was performed during the second heating cycle:

| Temperature | | heating rate | duration | |
|---|---|---|---|---|
| [° C.] | mode | [K/min] | [min] | heating cycle |
| 150 | dynamic | 40.0 | | 1^{st} heating |
| 150 | isothermal | 0.0 | 2 | |
| −130 | dynamic | Max | | |
| −130 | isothermal | 0.0 | 1 | |
| 152 | dynamic | 20.0 | | 2^{nd} heating |

The solid surfactant composition of the presently claimed invention has a glass transition temperature (T_{g}) of at least 50° C., determined by differential scanning calorimetry according to DIN EN ISO 11357-2, at a heating rate of 20 K/min.

In a preferred embodiment, the solid surfactant composition has a glass transition temperature (T_{g}) in the range of 50° C. to 130° C., more preferably in the range of 60° C. to 120° C. and most preferably in the range of 70° C. to 120° C., in each case determined by differential scanning calorimetry according to DIN EN ISO 11357-2, at a heating rate of 20 K/min.

In another aspect, the presently claimed invention is directed to the use of the solid surfactant composition in cleaning formulation. The solid surfactant composition of the presently claimed invention is advantageously suitable for use in cleaning formulation such as washing and cleaning compositions, in dishwashing compositions and in rinse aids.

Washing compositions in the context of the present invention are understood to mean those compositions which are used for cleaning flexible materials having high absorbency, for example materials having a textile character, whereas cleaning compositions in the context of the present invention are understood to mean those compositions which are used for cleaning materials having a closed surface, i.e. having a surface which has only few and small pores, if any, and consequently has zero or only low absorbency.

Examples of flexible materials having high absorbency are those which comprise or consist of natural, synthetic or semisynthetic fibre materials, and which accordingly generally have at least some textile character. The fibrous materials or materials consisting of fibres may in principle be present in any form which occurs in use or in manufacture and processing. For example, fibres may be present in unordered form in the form of staple or aggregate, in ordered form in the form of fibres, yarns, threads, or in the form of three-dimensional structures such as nonwovens, lodens or felt, wovens, knits, in all conceivable binding types. The fibres may be raw fibres or fibres in any desired stages of processing. Examples are natural protein or cellulose fibres, such as wool, silk, cotton, sisal, hemp or coconut fibres, or synthetic fibres, for example polyester, polyamide or polyacrylonitrile fibres.

Examples of materials having only few and small pores, if any, and having zero or only low absorbency are metal, glass, enamel or ceramic. Typical objects made of these materials are, for example, metallic sinks, cutlery, glass and porcelain dishware, bathtubs, washbasins, tiles, flags, cured synthetic resins, for example decorative melamine resin surfaces on kitchen furniture or painted metal surfaces, for example refrigerators and car bodies, printed circuit boards, microchips, sealed or painted woods, e.g. parquet or wall cladding, window frames, doors, plastics coverings such as floor coverings made of PVC or hard rubber, or rigid or flexible foams having substantially closed surfaces.

Examples of cleaning compositions comprising the inventive polymer composition comprise washing and cleaning compositions, dishwashing compositions such as manual dishwashing compositions or machine dishwashing compositions, metal degreasers, glass cleaners, floor cleaners, all-purpose cleaners, high-pressure cleaners, neutral cleaners, alkaline cleaners, acidic cleaners, spray degreasers, dairy cleaners, machinery cleaners in industry, especially the chemical industry, cleaners for car washing and also domestic all-purpose cleaners.

### Additives

The solid surfactant composition according to the present invention may further comprise at least one additive. The at least one additive is selected from the group consisting of hydrotrope, solubilizer, inorganic salt, organic acid, anionic surfactant and cationic surfactant. The at least one additive is present in an amount in the range of 0 to 10% by weight, based on the total weight of the solid surfactant composition.

### Hydrotrope/Solubilizer

The solid surfactant composition according to the present invention may further comprise at least one hydrotrope. The hydrotrope can comprise a hydrophilic-substituted aromatic hydrocarbon, and/or the alkali metal salt thereof, optionally having an alkyl or aryl side chain, more preferably the sodium salt of a sulfonated aromatic hydrocarbon and is most preferably selected from the group consisting essentially of: sodium benzoate, sodium 3-hydroxy-2-naphtoate, sodium xylene sulphonate, phosphate esters, sodium decyl diphenyl oxide, sodium dimethyl naphthalene sulphonate, sodium salts of linear alkyl benzene sulphonate, having from about C₈ to C₁₂ in the alkyl portion, as well as mixtures thereof.

### Inorganic Salt

The solid surfactant composition according to the present invention may further comprise an inorganic salt. The inorganic salt, if present, is selected from chloride, hydroxide, silicate, carbonate and bicarbonate of alkali metal or alkaline earth metal. Examples of the preferred inorganic salt are, but not restricted to sodium chloride, magnesium chloride, sodium carbonate, sodium bicarbonate, sodium sulfate.

### Organic Acid

The solid surfactant composition according to the present invention may comprise an organic acid. Typical examples of organic acid are the polycarboxylic acids which can be used in the form of their sodium salts, such as citric acid, adipic acid, succinic acid, glutaric acid, tartaric acid, sugar acids, aminocarboxylic acids, nitrilotriacetic acid (NTA), and mixtures thereof. Preferred salts are the salts of the polycarboxylic acids such as citric acid, adipic acid, succinic acid, glutaric acid, tartaric acid, sugar acids and mixtures thereof.

### Anionic Surfactant

The solid surfactant composition according to the present invention may comprise anionic surfactant. Typical examples of anionic surfactants are soaps, alkylsulfonates, alkylbenzenesulfonates, olefinsulfonates, methyl ester sulfonates, sulfo fatty acids, alkyl sulfates, monoalkyl sulfosuccinates and dialkyl sulfosuccinates, sulfotriglycerides, amide soaps, ethercarboxylic acids and salts thereof, fatty acid isethionates, fatty acid sarcosinates, fatty acid taurides, N-acylamino acids, such as, for example, acyl lactylates, acyl tartrates, acyl glutamates and acyl aspartates, alkyl oligoglucoside sulfates, alkylglucose carboxylates, protein fatty acid condensates and alkyl (ether) phosphates. Preferred surfactants of the sulfonate type are C₉-C₁₃ alkylbenzenesulfonates, olefinsulfonates, i.e. mixtures of alkene- and hydroxyalkanesulfonates, and also disulfonates, as are obtained, for example, from C₁₂-C₁₈-monoolefins with terminal or pendent double bond by sulfonation with gaseous sulfur trioxide and subsequent alkaline or acidic hydrolysis of the sulfonation products. Also, of suitability are alkanesulfonates, which are obtained from C₁₂-C₁₈-alkanes for example by sulfochlorination or sulfoxidation with subsequent hydrolysis and/or neutralization.

Likewise of suitability are also the esters of □-sulfo fatty acids (estersulfonates), for example the □-sulfonated methyl esters of hydrogenated coconut, palm kernel or tallow fatty acids. Further suitable anionic surfactants are sulfated fatty acid glycerol esters.

Fatty acid glycerol esters are to be understood as meaning, inter alia, the mono-, di and triesters, and mixtures thereof, as are obtained during the production by esterification of a monoglycerol with 1 to 3 mol of fatty acid or during the transesterification of triglycerides with 0.3 to 2 mol of glycerol. Preferred sulfated fatty acid glycerol esters here are the sulfation products of saturated fatty acids having 6 to 22 carbon atoms, for example of caproic acid, caprylic acid, capric acid, myristic acid, lauric acid, palmitic acid, stearic acid or behenic acid.

Preferred alk(en)yl sulfates are the alkali metal and in particular the sodium salts of the sulfuric acid half-esters of C₁₂-C₁₈-fatty alcohols, for example of coconut fatty alcohol, tallow fatty alcohol, lauryl, myristyl, cetyl or stearyl alcohol or of the C₁₀-C₂₀-oxo alcohols and the half-esters of secondary C₁₀-C₂₀-alcohols. Preference is furthermore given to alk(en)yl sulfates which comprise a synthetic straight-chain C₁₀-C₂₀-alkyl radical produced on a petrochemical basis. These have an analogous degradation behavior to the equivalent compounds based on fatty chemical raw materials. From the point of view of washing, the C₁₂-C₁₆-alkyl sulfates and C₁₂-C₁₅-alkyl sulfates and C₁₄-C₁₅-alkyl sulfates are preferred. The sulfuric acid monoesters of the straight-chain or branched C₇-C₂₁-alcohols ethoxylated with 1 to 6 mol of ethylene oxide, such as 2-methyl-branched C₉-C₁₁-alcohols having on average 3.5 mol of ethylene oxide (EO) or C₁₂-C₁₈-fatty alcohols having 1 to 4 EO, inter alia, are also suitable. They are usually used in cleaners only in relatively small amounts, for example in amounts from 1 to 5% by weight, on account of their high foam behavior. Further suitable anionic surfactants in the context of the present invention are also the salts of alkylsulfosuccinic acid, which are also referred to as sulfosuccinates or as sulfosuccinic acid esters and are the monoesters and/or diesters of sulfosuccinic acid with alcohols, preferably fatty alcohols and in particular ethoxylated fatty alcohols. Preferred sulfosuccinates comprise C₈-C₁₈-fatty alcohol radicals or mixtures of these. Particularly preferred sulfosuccinates comprise a fatty alcohol radical which is derived from ethoxylated fatty alcohols. The sulfosuccinates whose fatty alcohol radicals are derived from ethoxylated fatty alcohols with a narrow homolog distribution are particularly preferred. It is likewise also possible to use alk(en)ylsuccinic acid having preferably 8 to 18 carbon atoms in the alk(en)yl chain or salts thereof.

### Cationic Surfactant

The solid surfactant composition according to the present invention may comprise a cationic surfactant. Suitable cationic surfactants are C₇-C₂₅ alkylamines, N,N-dimethyl-N-(hydroxy C₇-C₂₅ alkyl)ammonium salts; mono- and di(C₇-C₂₅-alkyl)dimethylammonium compounds quaternized with alkylating agents; ester quats, in particular quaternary esterified mono-, di- and trialkanolamines esterified with C₈-C₂₂ carboxylic acids and imidazoline quats, in particular 1-alkylimidazolinium salts.

The present invention offers one or more of following advantages:
1. Solid surfactant composition with a high loading of nonionic surfactant.
2. The solid surfactant composition is prepared by adding carboxyl group-based polymers which contribute to the functional performance of the composition.
3. The solid nonionic surfactant composition can be used in a wide variety of solid cleaning formulations.

In the following, specific embodiments of the present invention are described:
1. A solid surfactant composition comprising
   (i) at least one polymer P1) that comprises polymerized units of at least one monomer A), selected from the group consisting of α, γ-ethylenically unsaturated carboxylic acids, salts of α,β-ethylenically unsaturated carboxylic acids, α, β-ethylenically unsaturated carboxylic acid anhydrides, mixtures thereof; and
   (ii) at least one nonionic surfactant of the general formula (I),

R₁-(A)ₓ-(B)_{y1}-(A)_{z}-(B)_{y2}—R₂ (I),
wherein
R₁ and R₂ independently denote H or linear or branched, substituted or unsubstituted C₁-C₂₂ alkyl,
A denotes CH₂—CH₂—O,
B denotes CH₂—CHR₃—O, wherein R₃ denotes H or linear or branched, unsubstituted C₁-C₁₀ alkyl,
x is an integer in the range from 0 to 35,
y₁ is an integer in the range from 0 to 60,
y₂ is an integer in the range from 0 to 35, and
z is an integer in the range from 0 to 35,
wherein the sum of x+y₁+z+y₂ is at least 1,
characterized in that the solid surfactant composition has a glass transition temperature (T_{g}) of at least 50° C., determined by differential scanning calorimetry according to DIN EN ISO 11357-2, at a heating rate of 20 K/min.
2. The solid surfactant composition comprising
   (i) 20% to 80% by weight of the total weight of the composition, at least one polymer P1) that comprises polymerized units of at least one monomer A), selected from the group consisting of α, β-ethylenically unsaturated carboxylic acids, salts of α,β-ethylenically unsaturated carboxylic acids, α, β-ethylenically unsaturated carboxylic acid anhydrides, and mixtures thereof, and
   (ii) 20% to 80% by weight of the total weight of the composition, at least one nonionic surfactant of the general formula (I),

R₁-(A)ₓ-(B)_{y1}-(A)_{z}-(B)_{y2}—R₂ (I),
wherein
R₁ and R₂ independently denote H or linear or branched, substituted or unsubstituted C₁-C₂₂ alkyl,
A denotes CH₂—CH₂—O,
B denotes CH₂—CHR₃—O, wherein R₃ denotes H or linear or branched, unsubstituted C₁-C₁₀ alkyl,
x is an integer in the range from 0 to 35,
y₁ is an integer in the range from 0 to 60,
y₂ is an integer in the range from 0 to 35, and
z is an integer in the range from 0 to 35,
wherein the sum of x+y₁+z+y₂ is at least 1,
characterized in that the solid surfactant composition has a glass transition temperature (T_{g}) of at least 50° C., determined by differential scanning calorimetry according to DIN EN ISO 11357 at a heating rate of 20 K/min.
3. The solid surfactant composition according to embodiment 1 or 2, wherein the at least one polymer P1) further comprises polymerized units of at least one monomer B) which is selected from the group consisting of unsaturated phosphonic acids, salts of unsaturated phosphonic acids, sodium phosphinate and mixtures thereof.
4. The solid surfactant composition according to embodiment 1 or 2, wherein the at least one monomer A) is selected from the group consisting of acrylic acid, methacrylic acid, maleic acid, fumaric acid, itaconic acid, ethacrylic acid, □-chloroacrylic acid, crotonic acid, aspartic acid, citraconic acid, mesaconic acid, glutaconic acid, aconitic acid, maleic anhydride, itaconic anhydride and salts thereof.
5. The solid surfactant composition according to embodiment 3, wherein the at least one monomer B) is selected from the group consisting of vinyl phosphonic acid, allyl phosphonic acid, sodium phosphinate, salts and mixtures thereof.
6. The solid surfactant composition according to one or more of embodiments 1 to 5, wherein the at least one polymer P1) is a homopolymer or a copolymer of acrylic acid, methacrylic acid, salts of acrylic acid, salts of methacrylic acid and sodium phosphinate.
7. The solid surfactant composition according to one or more of embodiments 1 to 6, wherein the at least one polymer P1) is a homopolymer of acrylic acid and salts thereof.
8. The solid surfactant composition according to one or more of embodiments 1 to 6, wherein the at least one polymer P1) is a copolymer of acrylic acid and sodium phosphinate.
9. The solid surfactant composition according to embodiments 1 to 8, wherein the at least one polymer P1) is selected from the group consisting of homopolymers of acrylic acid and copolymers of acrylic acid and sodium phosphinate.
10. The solid surfactant composition according to one or more of embodiments 1 to 9, wherein (i) the at least one polymer P1) has a weight average molecular weight in the range of 1,000 to 40,000 g/mol as determined by gel permeation chromatography.
11. The solid surfactant composition according to one or more of embodiments 1 to 10, wherein the pH of 10% aqueous solution of the at least one polymer P1) is in the range of 2 to 4.
12. The solid surfactant composition according to embodiment 1, wherein (ii) the at least one nonionic surfactant of the general formula (I) has an HLB value in the range of 2 to 17.
13. The solid surfactant composition according to embodiment 12, wherein (ii) the at least one nonionic surfactant of the general formula (I) has an HLB value in the range of 2 to 11 when R₂ is H.
14. The solid surfactant composition according to embodiment 12, wherein (ii) the at least one nonionic surfactant of the general formula (I) has an HLB value in the range of 2 to 17 when R₂ is linear or branched, substituted or unsubstituted C₁-C₂₂ alkyl.
15. The solid surfactant composition according to embodiment 1 or 2, wherein R₁ and R₂ independently are selected from the group consisting of H, methyl, ethyl, n-propyl, n-butyl, n-pentyl, n-hexyl, n-heptyl, n-octyl, n-nonyl, n-decyl, n-undecyl, n-dodecyl, n-tridecyl, n-tetradecyl, n-pentadecyl, n-hexadecyl, n-heptadecyl, n-octadecyl, n-nonadecyl, n-eicosyl, n-heneicosyl, n-docosyl, isopropyl, isobutyl, isopentyl, isohexyl, isoheptyl, isooctyl, isononyl, isodecyl, isoundecyl, isododecyl, isotridecyl, isotetradecyl, isopentadecyl, isohexadecyl, isoheptadecyl, isooctadecyl, isononadecyl, isoeicosyl, isoheneicosyl, isodocosyl, 2-propyl heptyl 2-ethyl hexyl and t-butyl.
16. The solid surfactant composition according to one or more of embodiments 1 to 15, wherein R₁ denotes linear or branched, unsubstituted C₁-C₂₂ alkyl, x is an integer in the range of 1 to 30, y₁ is an integer in the range of 0 to 30, y₂ is 0, z is 0, R₂ is H and wherein the sum of x+y₁+z+y₂ is at least 1.
17. The solid surfactant composition according to one or more of embodiments 1 to 15, wherein R₁ and R₂ each are H, x is an integer in the range of 1 to 25, y₁ is an integer in the range of 5 to 60, y₂ is 0, z is an integer in the range of 1 to 25 and wherein the sum of x+y₁+z+y₂ is at least 7.
18. The solid surfactant composition according to one or more of embodiments 1 to 15, wherein R₁ and R₂ each are selected from linear or branched, unsubstituted C₁-C₂₂ alkyl, x is an integer in the range of 1 to 25, y₁ is an integer in the range of 5 to 30, y₂ is 0, z is 0 and wherein the sum of x+y₁+z+y₂ is at least 6.
19. The solid surfactant composition according to one or more of embodiments 1 to 15, wherein R₁ and R₂ each is selected from linear or branched, unsubstituted C₁-C₂₂ alkyl, x is an integer in the range of 1 to 25, y₁ is an integer in the range of 1 to 30, y₂ is 0, z is an integer in the range of 1 to 20 and wherein the sum of x+y₁+z+y₂ is at least 3.
20. The solid surfactant composition according to one or more of embodiments 1 to 15, wherein R₁ and R₂ each are H, x is 0, y₁ is an integer in the range of 1 to 30, y₂ is an integer in the range of 1 to 30, z is an integer in the range of 1 to 20 and wherein the sum of x+y₁+z+y₂ is at least 3.
21. The solid surfactant composition according to embodiment 1 comprising
   (i) the at least one polymer P1) is selected from the group consisting of homopolymers of acrylic acid and copolymers of acrylic acid and sodium phosphinate; and
   (ii) the at least one nonionic surfactant of the general formula (I),

R₁-(A)ₓ-(B)_{y1}-(A)_{z}-(B)_{y2}—R₂ (I),
wherein
R₁ and R₂ independently denote H or linear or branched, substituted or unsubstituted C₁ to C₂₂ alkyl,
A denotes CH₂—CH₂—O,
B denotes CH₂—CHR₃—O, wherein R₃ denotes H or linear or branched, unsubstituted C₁-C₁₀ alkyl,
x is an integer in the range from 0 to 35,
y₁ is an integer in the range from 0 to 60,
y₂ is an integer in the range from 0 to 35, and
z is an integer in the range from 0 to 35,
wherein the sum of x+y₁+z+y₂ is at least 1, characterized in that the solid surfactant composition has a glass transition temperature (T_{g}) of at least 50° C., determined by differential scanning calorimetry according to DIN EN ISO 11357-2, at a heating rate of 20 K/min.
22. The solid surfactant composition according to embodiment 1, comprising
   (i) at least one homopolymer of acrylic acid; and
   (ii) at least one nonionic surfactant of the general formula (I) wherein R₁ denotes linear or branched, unsubstituted C₁-C₂₂ alkyl, x is an integer in the range of 1 to 30, y₁ is an integer in the range of 0 to 30, y₂ is 0, z is 0 and R₂ is H;
   wherein the sum of x+y₁+z+y₂ is at least 1;
   characterized in that the solid surfactant composition has a glass transition temperature (Tg) of at least 50° C., determined by differential scanning calorimetry according to DIN EN ISO 11357 at a heating rate of 20 K/min.
23. The solid surfactant composition according to embodiment 1, comprising
   (i) at least one copolymer of sodium phosphinate and acrylic acid; and
   (ii) at least one nonionic surfactant of the general formula (I) wherein R₁ denotes linear or branched, unsubstituted C₁-C₂₂ alkyl, x is an integer in the range of 1 to 30, y₁ is an integer in the range of 0 to 30, y₂ is 0, z is 0 and R₂ is H;
   wherein the sum of x+y₁+z+y₂ is at least 1;
   characterized in that the solid surfactant composition has a glass transition temperature (Tg) of at least 50° C., determined by differential scanning calorimetry according to DIN EN ISO 11357 at a heating rate of 20 K/min.
24. The solid surfactant composition according to embodiment 1, comprising
   (i) the at least one polymer P1) is selected from the group consisting of homopolymers of acrylic acid and copolymers of acrylic acid and sodium phosphinate; and
   (ii) the at least one nonionic surfactant of the general formula (I) wherein R₁ denotes linear or branched, unsubstituted C₁-C₂₂ alkyl, x is an integer in the range of 1 to 30, y₁ is an integer in the range of 0 to 30, y₂ is 0, z is 0 and R₂ is H;
   wherein the sum of x+y₁+z+y₂ is at least 1;
   characterized in that the solid surfactant composition has a glass transition temperature (Tg) of at least 50° C., determined by differential scanning calorimetry according to DIN EN ISO 11357 at a heating rate of 20 K/min.
25. The solid surfactant composition according to embodiment 1, comprising
   (i) at least one homopolymer of acrylic acid; and
   (ii) at least one nonionic surfactant of the general formula (I) wherein R₁ and R₂ each are H, x is an integer in the range of 1 to 25, y₁ is an integer in the range of 5 to 50, y₂ is 0 and z is an integer in the range of 1 to 25;
   wherein the sum of x+y₁+z+y₂ is at least 7,
   characterized in that the solid surfactant composition has a glass transition temperature (Tg) of at least 50° C., determined by differential scanning calorimetry according to DIN EN ISO 11357 at a heating rate of 20 K/min.
26. The solid surfactant composition according to embodiment 1, comprising
   (i) at least one copolymer of sodium phosphinate and acrylic acid; and
   (ii) at least one nonionic surfactant of the general formula (I) wherein R₁ and R₂ each are H, x is an integer in the range of 1 to 25, y₁ is an integer in the range of 5 to 50, y₂ is 0 and z is an integer in the range of 1 to 25;
   wherein the sum of x+y₁+z+y₂ is at least 6;
   characterized in that the solid surfactant composition has a glass transition temperature (Tg) of at least 50° C., determined by differential scanning calorimetry according to DIN EN ISO 11357 at a heating rate of 20 K/min.
27. The solid surfactant composition according to embodiment 1, comprising
   (i) the at least one polymer P1) is selected from the group consisting of homopolymers of acrylic acid and copolymers of acrylic acid and sodium phosphinate; and
   (ii) at least one nonionic surfactant of the general formula (I) wherein R₁ and R₂ each are H, x is an integer in the range of 1 to 25, y₁ is an integer in the range of 5 to 60, y₂ is 0 and z is an integer in the range of 1 to 25;
   wherein the sum of x+y₁+z+y₂ is at least 7;
   characterized in that the solid surfactant composition has a glass transition temperature (Tg) of at least 50° C., determined by differential scanning calorimetry according to DIN EN ISO 11357 at a heating rate of 20 K/min.
28. The solid surfactant composition according to embodiment 1, comprising
   (i) at least one homopolymer of acrylic acid; and
   (ii) at least one nonionic surfactant of the general formula (I) wherein R₁ and R₂ each are selected from linear or branched, unsubstituted C₁-C₂₂ alkyl, x is an integer in the range of 1 to 25, y₁ is an integer in the range of 5 to 30, y₂ is 0 and z is 0;
   wherein the sum of x+y₁+z+y₂ is at least 6;
   characterized in that the solid surfactant composition has a glass transition temperature (Tg) of at least 50° C., determined by differential scanning calorimetry according to DIN EN ISO 11357 at a heating rate of 20 K/min.
29. The solid surfactant composition according to embodiment 1, comprising
   (i) at least one copolymer of sodium phosphinate and acrylic acid; and
   (ii) at least one nonionic surfactant of the general formula (I) wherein R₁ and R₂ each are selected from linear or branched, unsubstituted C₁-C₂₂ alkyl, x is an integer in the range of 1 to 25, y₁ is an integer in the range of 5 to 30, y₂ is 0 and z is 0;
   wherein the sum of x+y₁+z+y₂ is at least 6;
   characterized in that the solid surfactant composition has a glass transition temperature (Tg) of at least 50° C., determined by differential scanning calorimetry according to DIN EN ISO 11357 at a heating rate of 20 K/min.
30. The solid surfactant composition according to embodiment 1, comprising
   (i) the at least one polymer P1) is selected from the group consisting of homopolymers of acrylic acid and copolymers of acrylic acid and sodium phosphinate; and
   (ii) at least one nonionic surfactant of the general formula (I) wherein R₁ and R₂ each are selected from linear or branched, unsubstituted C₁-C₂₂ alkyl, x is an integer in the range of 1 to 25, y₁ is an integer in the range of 5 to 30, y₂ is 0 and z is 0;
   wherein the sum of x+y₁+z+y₂ is at least 6;
   characterized in that the solid surfactant composition has a glass transition temperature (Tg) of at least 50° C., determined by differential scanning calorimetry according to DIN EN ISO 11357 at a heating rate of 20 K/min.
31. The solid surfactant composition according to embodiment 1, comprising
   (i) at least one homopolymer of acrylic acid; and
   (ii) at least one nonionic surfactant of the general formula (I) wherein R₁ and R₂ each are selected from linear or branched, unsubstituted C₁-C₂₂ alkyl, x is an integer in the range of 1 to 25, y₁ is an integer in the range of 1 to 30, y₂ is 0 and z is an integer in the range of 1 to 20;
   wherein the sum of x+y₁+z+y₂ is at least 3;
   characterized in that the solid surfactant composition has a glass transition temperature (Tg) of at least 50° C., determined by differential scanning calorimetry according to DIN EN ISO 11357 at a heating rate of 20 K/min.
32. The solid surfactant composition according to embodiment 1, comprising
   (i) at least one copolymer of sodium phosphinate and acrylic acid; and
   (ii) at least one nonionic surfactant of the general formula (I) wherein R₁ and R₂ each are selected from linear or branched, unsubstituted C₁-C₂₂ alkyl, x is an integer in the range of 1 to 25, y₁ is an integer in the range of 1 to 30, y₂ is 0 and z is an integer in the range of 1 to 20;
   wherein the sum of x+y₁+z+y₂ is at least 3;
   characterized in that the solid surfactant composition has a glass transition temperature (Tg) of at least 50° C., determined by differential scanning calorimetry according to DIN EN ISO 11357 at a heating rate of 20 K/min.
33. The solid surfactant composition according to embodiment 1, comprising
   (i) the at least one polymer P1) is selected from the group consisting of homopolymers of acrylic acid and copolymers of acrylic acid and sodium phosphinate; and
   (ii) at least one nonionic surfactant of the general formula (I) wherein R₁ and R₂ each are selected from linear or branched, unsubstituted C₁-C₂₂ alkyl, x is an integer in the range of 1 to 25, y₁ is an integer in the range of 1 to 30, y₂ is 0 and z is an integer in the range of 1 to 20;
   wherein the sum of x+y₁+z+y₂ is at least 3;
   characterized in that the solid surfactant composition has a glass transition temperature (Tg) of at least 50° C., determined by differential scanning calorimetry according to DIN EN ISO 11357 at a heating rate of 20 K/min.
34. The solid surfactant composition according to embodiment 1, comprising
   (i) at least one homopolymer of acrylic acid; and
   (ii) at least one nonionic surfactant of the general formula (I) wherein R₁ and R₂ each are H, x is 0, y₁ is an integer in the range of 1 to 30, y₂ is an integer in the range of 1 to 30, z is an integer in the range of 1 to 20;
   wherein the sum of x+y₁+z+y₂ is at least 3;
   characterized in that the solid surfactant composition has a glass transition temperature (Tg) of at least 50° C., determined by differential scanning calorimetry according to DIN EN ISO 11357 at a heating rate of 20 K/min.
35. The solid surfactant composition according to embodiment 1, comprising
   (i) at least one copolymer of sodium phosphinate and acrylic acid; and
   (ii) at least one nonionic surfactant of the general formula (I) wherein R₁ and R₂ each are H, x is 0, y₁ is an integer in the range of 1 to 30, y₂ is an integer in the range of 1 to 30, z is an integer in the range of 1 to 20;
   wherein the sum of x+y₁+z+y₂ is at least 3;
   characterized in that the solid surfactant composition has a glass transition temperature (Tg) of at least 50° C., determined by differential scanning calorimetry according to DIN EN ISO 11357 at a heating rate of 20 K/min.
36. The solid surfactant composition according to embodiment 1, comprising
   (i) the at least one polymer P1) is selected from the group consisting of homopolymers of acrylic acid and copolymers of acrylic acid and sodium phosphinate; and
   (ii) at least one nonionic surfactant of the general formula (I) wherein R₁ and R₂ each are H, x is 0, y₁ is an integer in the range of 1 to 30, y₂ is an integer in the range of 1 to 30, z is an integer in the range of 1 to 20;
   wherein the sum of x+y₁+z+y₂ is at least 3;
   characterized in that the solid surfactant composition has a glass transition temperature (Tg) of at least 50° C., determined by differential scanning calorimetry according to DIN EN ISO 11357 at a heating rate of 20 K/min.
37. The solid surfactant composition according to one or more of embodiments 1 to 35, wherein (i) the at least one Polymer P1) and (ii) the at least one nonionic surfactant of the general formula (I) are present in the weight ratio of 2.0:1.0 to 1.0:1.2.
38. The solid surfactant composition according to one or more of embodiments 1 to 36, further comprising at least one additive.
39. The solid surfactant composition according to embodiment 37, wherein the at least one additive is selected from the group consisting of hydrotrope, solubilizer, inorganic salt, organic acid, anionic surfactant and cationic surfactant.
40. The solid surfactant composition according to embodiment 37 or 38, wherein the at least one additive is present in an amount in the range of 0 to 10% by weight, based on the total weight of the solid surfactant composition.

While the presently claimed invention has been described in terms of its specific embodiments, certain modifications and equivalents will be apparent to those skilled in the art and are intended to be included within the scope of the presently claimed invention

### EXAMPLES

The presently claimed invention is illustrated in detail by non-restrictive working examples which follow. More particularly, the test methods specified hereinafter are part of the general disclosure of the application and are not restricted to the specific working examples.

### Compounds

Polyacrylic acid (Mw 4000 g/mol and Mn: 2500 g/mol, 55 wt. % aqueous solution, pH of 10% in water is 2.5)

Acrylic acid-sodium hypophosphite copolymer (CAS no. 71050-62-9) are obtained from BASF SE.

Suitable nonionic surfactant of the general formula (I) are as listed in Table 4

TABLE 4

| | | | | | | | | HLB |
|---|---|---|---|---|---|---|---|---|
| Surfactant | R₁ | x | y₁ | z | y₂ | R₂ | R₃ | value |
| Surfactant 1 | C₁₀ | 0 | 3 | 15 | 18 | H | methyl | 6.40 |
| | branched, | | | | | | | |
| | unsubstituted | | | | | | | |
| Surfactant 2 | C₁₃-C₁₅ | 9.8 | 2.1 | 0 | 0 | H | ethyl | 10.5 |
| | linear and | | | | | | | |
| | branched, | | | | | | | |
| | unsubstituted | | | | | | | |
| Surfactant 3 | C₁₃-C₁₅ | 6.1 | 1.9 | 0 | 0 | H | ethyl | 8.90 |
| | linear | | | | | | | |
| | and | | | | | | | |
| | branched, | | | | | | | |
| | unsubstituted | | | | | | | |
| Surfactant 4 | C₁₃-C₁₅ | 4.8 | 2 | 0 | 0 | H | ethyl | 7.7 |
| | branched, | | | | | | | |
| | unsubstituted | | | | | | | |
| Surfactant 5 | C₁₂-C₁₅, | 0 | 5 | 2.5 | 0 | H | methyl | 3.4 |
| | linear and | | | | | | | |
| | branched, | | | | | | | |
| | unsubstituted | | | | | | | |
| Surfactant 6 | C₁₂-C₁₅, | 3.5 | 5.5 | 0 | 0 | H | methyl | 4.80 |
| | linear and | | | | | | | |
| | branched, | | | | | | | |
| | unsubstituted | | | | | | | |
| Surfactant 7 | C₁₀ | 5.4 | 4.7 | 0.5 | 0 | H | methyl | 7.60 |
| | branched, | | | | | | | |
| | unsubstituted | | | | | | | |
| Surfactant 8 | C₁₆-C₁₈, | 3.9 | 14 | 0 | 0 | H | methyl | 2.80 |
| | linear and | | | | | | | |
| | branched, | | | | | | | |
| | unsubstituted | | | | | | | |
| Surfactant 9 | C₁₂-C₁₄, | 3 | 6 | 0 | 0 | H | methyl | 3.90 |
| | linear and | | | | | | | |
| | branched, | | | | | | | |
| | unsubstituted | | | | | | | |
| Surfactant 10 | C₁₂-C₁₈, | 10 | 0 | 0 | 0 | butyl | H | 12.70 |
| | linear and | | | | | | | |
| | branched, | | | | | | | |
| | unsubstituted | | | | | | | |
| Surfactant 11 | H | 2 | 16 | 1 | 0 | H | methyl | 2.00 |
| Surfactant 12 | H | 2 | 26 | 1 | 0 | H | methyl | 2.00 |
| Surfactant 13 | H | | | 1 | 0 | H | methyl | 2.00 |
| Surfactant 14 | H | 5 | 47 | 1 | 0 | H | methyl | 2.00 |
| Surfactant 15 | H | 0 | 20-25 | 5-15 | 20-25 | H | methyl | 4.00 |
| Surfactant 16 | C₁₃ | 2 | 0 | 0 | 0 | H | — | 6.1 |
| | branched, | | | | | | | |
| | unsubstituted | | | | | | | |

### Methods

Number-Average Molecular Weight (Mₙ), Weight-Average Molecular Weight (M_{w}) and Polydispersity

Number-average molecular weight (Mₙ), weight-average molecular weight (M_{w}) and polydispersity of the polymer are determined by gel permeation chromatography (GPC): Eluent 0.01 mol/l phosphate buffer, column set of 2 separating columns of column length 30 cm each, column temperature 35° C., pH=7.4, +0.01 M NaN₃ in deionized water. For calibration, polyacrylic acid (neutralized) standard is used. Flow rate is 0.8 mL/min, concentration 2 mg/mL, injection 100 μL. Detector: RID (Refractive Index Detector) Agilent 1200”.

### Hydrophilic-Lipophilic Balance (HLB) Value

The hydrophilic-lipophilic balance of a surfactant is a measure of the degree to which it is hydrophilic or lipophilic, determined by calculating values for the different regions of the molecule, as described by Griffin in 1954 according to the following equation

HLB=20*Mₕ/M

where Mₕ is the molecular mass of the hydrophilic portion of the Molecule, and M is the molecular mass of the whole molecule. Only the EO part in the surfactants is regarded as hydrophilic, all other parts contribute only to the whole molecule.

The results are obtained on an arbitrary scale of 0 to 20. An HLB value of 0 corresponds to a completely hydrophobic molecule, and a value of 20 would correspond to a molecule made up completely of hydrophilic components.

### Glass Transition Temperature

The glass transition temperature (T_{g}) of the solid surfactant composition is determined by differential scanning calorimetry according to DIN EN ISO 11357-2. The following temperature profile was applied, and the measurement was performed during the second heating cycle:

| Temperature | | heating rate | duration | |
|---|---|---|---|---|
| [° C.] | mode | [K/min] | [min] | Heating cycle |
| 150 | dynamic | 40.0 | | 1^{st} heating |
| 150 | isothermal | 0.0 | 2 | |
| −130 | dynamic | Max | | |
| −130 | isothermal | 0.0 | 1 | |
| 152 | dynamic | 20.0 | | 2^{nd} heating |

### General Procedure for Synthesis

The non-ionic surfactant and the polymer were filled into a SpeedMixer™ (9100 Hauschild DAC. 400 FVZ Laboratory Speedmixer) and tempered to 60° C. before being mixed at 2500 rpm for 150 seconds. The resulting aqueous polymer-surfactant blends were freeze dried for 3 days followed by vacuum drying at a pressure of 30 mbar and a temperature of 60° C., for 12 hours in a vacuum drying oven to obtain solid polymer-surfactant compositions of example 1-23.

TABLE 5
Surfactant-polymer composition
comprising surfactant 1 and polyacrylic acid

| | Amount of | Amount of | Glass transition | |
|---|---|---|---|---|
| Example | Polyacrylic | Surfactant | temperature | Physical |
| no. | polymer | 1 | Tg (° C.) | state |
| 1 | 67% | 33% | 111 | solid |
| 2 | 50% | 50% | 101 | solid |
| 3 | 25% | 75% | 104 | Solid/wet surface |
| 4 | 33% | 67% | 102 | Solid/wet surface |
| 5 | 43% | 57% | 94 | solid |
| 6 | 50% | 50% | 111 | solid |
| 7 | 60% | 40% | 114 | solid |
| 8 | 67% | 33% | 113 | solid |

As is evident in table-5, a higher amount of polymer in the surfactant-polymer composition leads to a higher glass transition temperature.

TABLE 6
Composition of each of surfactant 2 to 17 and
polyacrylic acid polymer in the ratio of 1:1

| | | Glass transition | |
|---|---|---|---|
| | | temperature Tg | Physical |
| Example no. | Surfactant | (° C.) | state |
| 9 | Surfactant 2 | 109 | solid |
| 10 | Surfactant 3 | 104.6 | solid |
| 11 | Surfactant 4 | 103 | solid |
| 12 | Surfactant 5 | 99.1 | solid |
| 13 | Surfactant 6 | 92.7 | solid |
| 14 | Surfactant 7 | 94.8 | solid |
| 15 | Surfactant 8 | 81 | solid |
| 16 | Surfactant 9 | 83.9 | solid |
| 17 | Surfactant 10 | 90.5 | solid |
| 18 | Surfactant 11 | 96.7 | solid |
| 19 | Surfactant 12 | 103.6 | solid |
| 20 | Surfactant 13 | 111.3 | solid |
| 21 | Surfactant 14 | 101.7 | solid |
| 22 | Surfactant 15 | 111.2 | solid |
| 23 | Surfactant 16 | 88.5 | solid |

Surfactant polymer compositions of example 9-23 were prepared by mixing surfactants 2-16 respectively and polyacrylic acid polymer in the ratio of 1:1, according to the general procedure of synthesis. By the process of the present invention, solid polymer-surfactant compositions are obtained which have high glass transition temperature (T_{g}), indicating that they retain the solid state at high temperature and hence do not melt under fluctuating temperature conditions arising due to storage or transportation. As the hydrophilic-lipophilic balance (HLB) value of the surfactant increases, a decrease in the glass transition temperature is observed. The solid surfactant compositions of desired T_{g} can be obtained by selecting the surfactant of low or high HLB.

1. A solid surfactant composition comprising
(i) at least one polymer P1) that comprises polymerized units of at least one monomer A) selected from the group consisting of α, β-ethylenically unsaturated carboxylic acids, salts of α, β-ethylenically unsaturated carboxylic acids, α, β-ethylenically unsaturated carboxylic acid anhydrides and mixtures thereof, and
(ii) at least one nonionic surfactant of the general formula (I),
R₁-(A)ₓ-(B)_{y1}-(A)_{z}-(B)_{y2}—R₂ (I),
wherein
R₁ and R₂ independently denote H or linear or branched, substituted or unsubstituted C₁-C₂₂ alkyl
A denotes CH₂—CH₂—O
B denotes CH₂—CHR₃—O, wherein R₃ denotes H or linear or branched, unsubstituted C₁-C₁₀ alkyl,
x is an integer in the range from 0 to 35,
y₁ is an integer in the range from 0 to 60,
y₂ is an integer in the range from 0 to 35, and
z is an integer in the range from 0 to 35,
wherein the sum of x+y₁+z+y₂ is at least 1,
characterized in that the solid surfactant composition has a glass transition temperature (T_{g}) of at least 50° C., determined by differential scanning calorimetry according to DIN EN ISO 11357-2, at a heating rate of 20 K/min.

2. The solid surfactant composition according to claim 1, wherein the at least one polymer P1) further comprises polymerized units of at least one monomer B) which is selected from the group consisting of unsaturated phosphonic acids, salts of unsaturated phosphonic acids, sodium phosphinate and mixtures thereof.

3. The solid surfactant composition according to claim 1, wherein the at least one polymer P1) is a homopolymer or a copolymer of acrylic acid, methacrylic acid, salts of acrylic acid, salts of methacrylic acid and sodium phosphinate.

4. The solid surfactant composition according to claim 1, wherein the at least one polymer P1) is a copolymer of acrylic acid and sodium phosphinate.

5. The solid surfactant composition according to claim 1, wherein the at least one polymer P1) has a weight average molecular weight in the range of 1,000 to 40,000 g/mole as determined by gel permeation chromatography.

6. The solid surfactant composition according to claim 1, wherein the pH of a 10% aqueous solution of the at least one polymer P1) is in the range of 2 to 4.

7. The solid surfactant composition according to claim 1, wherein the at least one nonionic surfactant of the general formula (I) has an HLB value in the range of 2 to 17.

8. The solid surfactant composition according to claim 7, wherein the at least one nonionic surfactant of the general formula (I) has an HLB value in the range of 2 to 11, when R₂ is H.

9. The solid surfactant composition according to claim 7, wherein the at least one nonionic surfactant of the general formula (I) has an HLB value in the range of 2 to 17, when R₂ is linear or branched, substituted or unsubstituted C₁-C₂₂ alkyl.

10. The solid surfactant composition according to claim 1, wherein R₁ denotes linear or branched, unsubstituted C₁-C₂₂ alkyl, x is an integer in the range of 1 to 30, y₁ is an integer in the range of 0 to 30, y₂ is 0, z is 0, R₂ is H and wherein the sum of x+y₁+z+y₂ is at least 1.

11. The solid surfactant composition according to claim 1, wherein R₁ and R₂ each are H, x is an integer in the range of 1 to 25, y₁ is an integer in the range of 5 to 60, y₂ is 0, z is an integer in the range of 1 to 25 and wherein the sum of x+y₁+z+y₂ is at least 7.

12. The solid surfactant composition according to claim 1, wherein R₁ and R₂ each are selected from the group consisting of linear or branched, unsubstituted C₁-C₂₂ alkyl, x is an integer in the range of 1 to 25, y₁ is an integer in the range of 5 to 30, y₂ is 0, z is 0 and wherein the sum of x+y₁+z+y₂ is at least 6.

13. The solid surfactant composition according to claim 1, wherein R₁ and R₂ each are selected from the group consisting of linear or branched, unsubstituted C₁-C₂₂ alkyl, x is an integer in the range of 1 to 25, y₁ is an integer in the range of 1 to 30, y₂ is 0, z is an integer in the range of 1 to 20 and wherein the sum of x+y₁+z+y₂ is at least 3.

14. The solid surfactant composition according to claim 1, wherein R₁ and R₂ each are H, x is 0, y₁ is an integer in the range of 1 to 30, y₂ is an integer in the range of 1 to 30, z is an integer in the range of 1 to 20 and wherein the sum of x+y₁+z+y₂ is at least 3.

15. A solid surfactant composition comprising
(i) at least one polymer P1) selected from the group consisting of homopolymers of acrylic acid and copolymers of acrylic acid and sodium phosphinate; and
(ii) at least one nonionic surfactant of the general formula (I),
R₁-(A)ₓ-(B)_{y1}-(A)_{z}-(B)y₂-R₂ (I),
wherein
R₁ and R₂ independently denote H or linear or branched, substituted or unsubstituted C₁-C₂₂ alkyl,
A denotes CH₂—CH₂—O,
B denotes CH₂—CHR₃—O, wherein R₃ denotes H or linear or branched, unsubstituted C₁-C₁₀ alkyl,
x is an integer in the range from 0 to 35,
y₁ is an integer in the range from 0 to 60,
y₂ is an integer in the range from 0 to 35, and
z is an integer in the range from 0 to 35,
wherein the sum of x+y₁+z+y₂ is at least 1,
characterized in that the solid surfactant composition has a glass transition temperature (T_{g}) of at least 50° C., determined by differential scanning calorimetry according to DIN EN ISO 11357-2, at a heating rate of 20 K/min.
